(19) United States
(12) Patent Application Publication
(10) Pub. No.: US 2019/0319373 A1
(43) Pub. Date: Oct. 17, 2019

(54) TERMINALIZED ELECTRIC WIRE

(71) Applicant: Yazaki Corporation, Tokyo (JP)

(72) Inventors: Shigeo Mori, Shizuoka (JP); Yasuhiro Otsuta, Shizuoka (JP); Takashi Ishihara, Shizuoka (JP)

(21) Appl. No.: 16/377,097

(22) Filed: Apr. 5, 2019

(30) Foreign Application Priority Data
Apr. 13, 2018 (JP) 2018-077367

(51) Int. Cl. H01R 4/30

(52) U.S. Cl. CPC H01R 4/30

(57) ABSTRACT

Provided is an electric wire part including a conductive core wire and a terminal part in which an object to be terminalized of the core wire is solidified into a terminal shape after being melted. The terminal part includes a connection part having a first through hole for inserting a male screw part therethrough, and a projecting part projecting from the connection part in at least one axial direction of the first through hole. The projecting part is formed in an annular shape having a second through hole communicated to the first through hole with the axial direction identical to an axial direction of the first through hole, and an end surface at a projecting direction side of the annular shape that is able to come into surface contact with a contact surface of a counterpart connection part serving as an object to be fastened.

### CROSS-REFERENCE TO RELATED APPLICATION(S)

The present application claims priority to and incorporates by reference the entire contents of Japanese Patent Application No. 2018-077367 filed in Japan on Apr. 13, 2018.

### BACKGROUND OF THE INVENTION

### 1. Field of the Invention

The present invention relates to a terminalized electric wire.

### 2. Description of the Related Art

Conventionally, a technique related to what is called a terminalized electric wire in which a part of a core wire of the electric wire is formed into a desired terminal shape, instead of fixing a terminal fitting to the electric wire has been known. In such a technique, for example, the core wire is exposed by stripping a covering material of the electric wire, and an object to be terminalized of the stripped portion is interposed between a pair of electrodes. Current is applied to the pair of electrodes, while pressure is applied to the object to be terminalized. Consequently, the object to be terminalized of the core wire is heated and melted while being pressurized. Then, in this technique, the application of current to the pair of electrodes is stopped, the object to be terminalized is cooled while being pressurized, and the solidification of the melted core wire is to be waited. In this process, a shape corresponding to a desired terminal shape is formed on each of the pair of electrodes. Thus, the object to be terminalized is formed into a terminal part having a desired terminal shape. For example, the following Japanese Patent Application Laid-open No. 2016-1572 discloses such a terminalized electric wire. The terminal part of the terminalized electric wire disclosed in Japanese Patent Application Laid-open No. 2016-1572 is formed in a round-shaped terminal. The terminal part includes an annular connection part, and the terminal part is fastened to a counterpart connection part, with a male screw part inserted into a through hole in the middle of the connection part.

In the conventional terminal part as described above, the annular connection part is fastened to the counterpart connection part using a screw member, while one of the plain surfaces of the connection part is brought into surface contact with the counterpart connection part. In the terminal part, the surface pressure of the contact part mainly affects the contact resistance between the connection part and the counterpart connection part. Thus, by keeping the surface pressure to a predetermined magnitude, it is possible to prevent the increase in the contact resistance and ensure a good conduction state between the connection part and the counterpart connection part. However, with the conventional terminal part, the surface pressure (contact resistance) between the connection part and the counterpart connection part is possibly changed depending on the shape of the annular connection part. Thus, the contact resistance is possibly increased with the reduction in the surface pressure. In other words, flexibility in setting the shape of a terminal part is not high in the conventional terminalized electric wire.

### SUMMARY OF THE INVENTION

Consequently, an object of the present invention is to provide a terminalized electric wire capable of increasing the flexibility of setting the shape of a terminal part.

A terminalized electric wire according to one aspect of the present invention includes an electric wire part including a conductive core wire; and a terminal part in which an object to be terminalized of the core wire is solidified into a terminal shape after being melted, wherein the terminal part includes a connection part having a first through hole for inserting a male screw part therethrough, and a projecting part projecting from the connection part in one of axial directions of the first through hole, the projecting part is formed in an annular shape including a second through hole communicated to the first through hole with an axial direction identical to an axial direction of the first through hole, and an end surface at a projecting direction side of the annular shape that is able to come into surface contact with a contact surface of a counterpart connection part serving as an object to be fastened, and an outer diameter of an outer peripheral surface of the projecting part is set so as to be equal to or more than a seat effective diameter of a screw member for fastening that is disposed at an opposite side to the projecting part in the connection part, and equal to or less than an outer diameter of an intersection circle between a curved surface of a cone of influence relating to the screw member and the contact surface of the counterpart connection part.

According to another aspect of the present invention, in the terminalized electric wire, it is preferable that the projecting part is formed in an annular cylindrical shape or an annular truncated conical cylindrical shape having the outer peripheral surface.

According to still another aspect of the present invention, in the terminalized electric wire, it is preferable that the projecting part is provided on at least one of both ends of the connection part in the axial direction of the first through hole.

According to still another aspect of the present invention, in the terminalized electric wire, it is preferable that the connection part and the projecting part are disposed so that the first through hole and the second through hole become concentric.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a terminalized electric wire of an embodiment;

FIG. 2 is a plan view illustrating the terminalized electric wire of the embodiment;

FIG. 3 is a sectional view cut along the line X-X in FIG. 2;

FIG. 4 is a sectional view illustrating a fastened state between a terminal part and a counterpart connection part;

FIG. 5 is a sectional view for explaining the setting condition of a projecting part; and

FIG. 6 is a perspective view for explaining a part of a process of terminalization.

### DETAILED DESCRIPTION OF THE PREFERRED EMBODIMENTS

Hereinafter, an embodiment of a terminalized electric wire according to the present invention will be described in detail with reference to the accompanying drawings. It is to be noted that the present invention is not limited to the embodiment.

### Embodiment

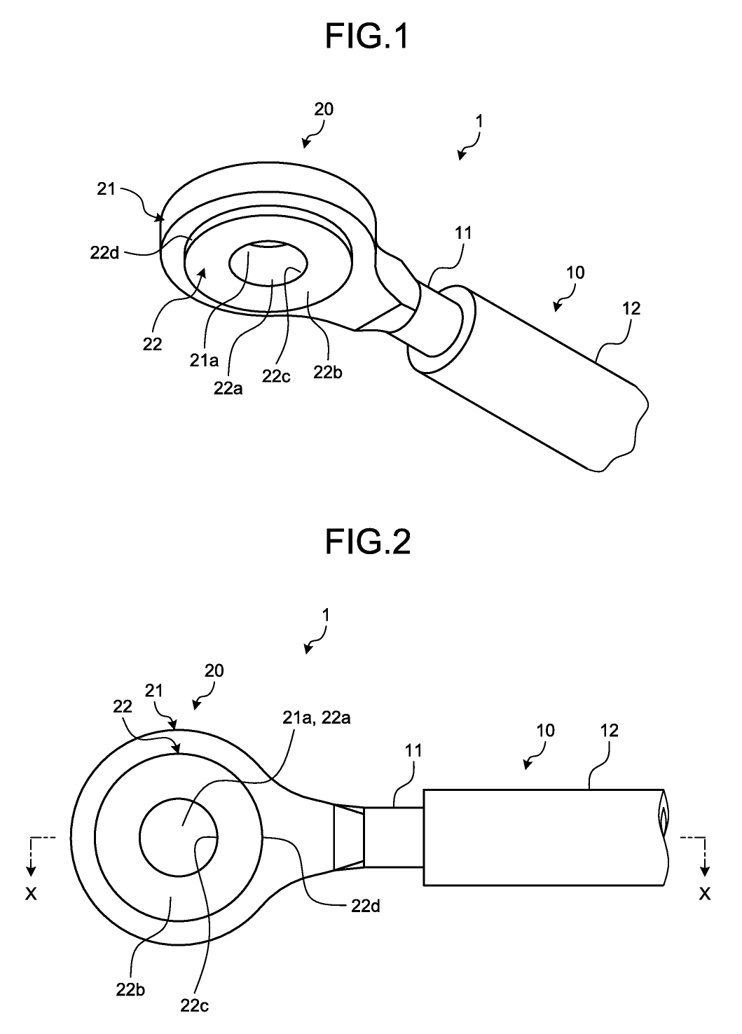

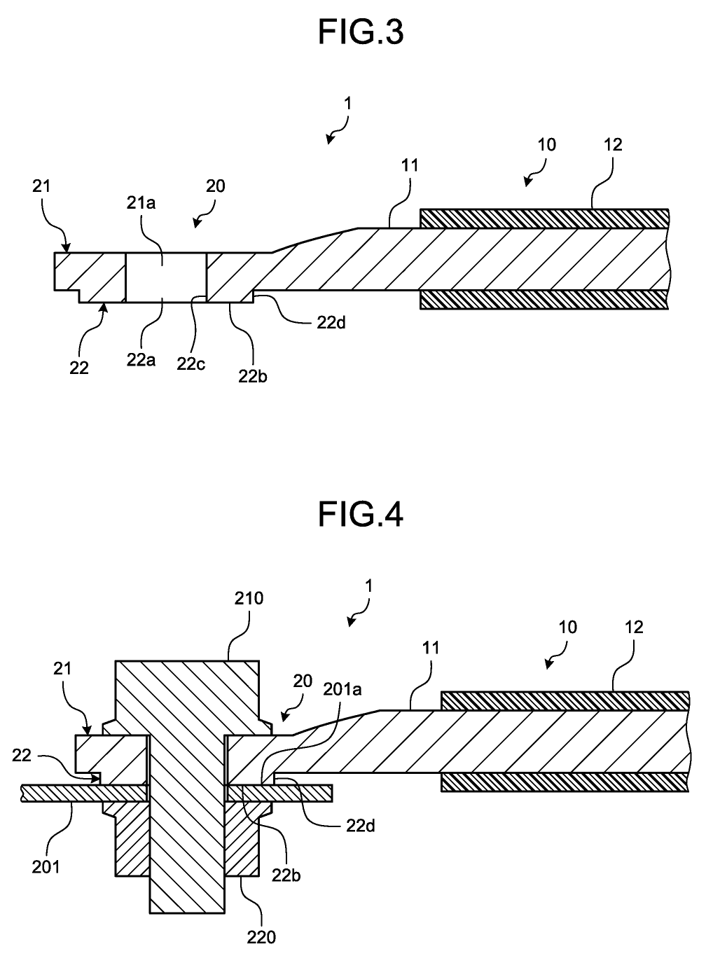

An embodiment of a terminalized electric wire according to the present invention will be described with reference to FIG. 1 to FIG. 6.

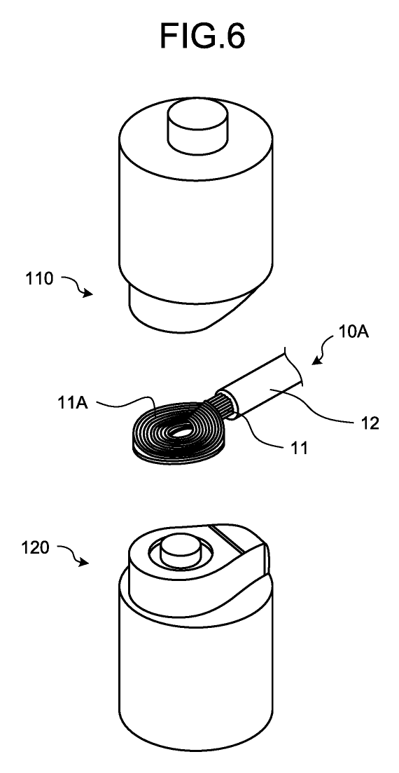

A reference numeral 1 in FIG. 1 to FIG. 5 is a terminalized electric wire of the present embodiment. The terminalized electric wire 1 is obtained by transforming a part of a core wire 11 of an electric wire 10A illustrated in FIG. 6 into a desired terminal shape. The terminalized electric wire 1 includes an electric wire part 10 and a terminal part 20.

The electric wire 10A includes a conductive core wire 11 and an insulating covering material 12 that covers the core wire 11 (FIG. 6). The core wire 11 may be made by bundling a plurality of metal strands or may be a single linear conductor. For example, the core wire 11 is made of aluminum or aluminum alloy. In the electric wire 10A, an object to be terminalized 11A is an exposed portion of the core wire 11 that is uncovered by stripping off the covering material 12 or the like.

The electric wire part 10 of the terminalized electric wire 1 is a remaining portion of the electric wire 10A from which the object to be terminalized 11A is removed, and a portion of the core wire 11 covered by the covering material 12. Moreover, the terminal part 20 of the terminalized electric wire 1 is a portion of the object to be terminalized 11A of the core wire 11 of the electric wire 10A that is solidified into a desired terminal shape after being melted.

In the electric wire 10A, the object to be terminalized 11A is temporally bent into an annular shape. The annular object to be terminalized 11A is formed into the terminal part 20 having a desired terminal shape, by a cold pressure welding, a resistance welding, and the like, using a pair of first electrode 110 and second electrode 120 illustrated in FIG. 6. Although a specific illustration is omitted, the first electrode 110 and the second electrode 120 are pressed electrodes that have conductivity and high thermal conductivity, and that are made of a material having a higher melting point than that of the core wire 11. The first electrode 110 and the second electrode 120 sandwich the ring-shaped object to be terminalized 11A therebetween. The first electrode 110 and the second electrode 120 form the object to be terminalized 11A into the terminal part 20 having a desired terminal shape, by pressurizing, heating, and cooling the object to be terminalized 11A with the object to be terminalized 11A interposed therebetween.

More specifically, the terminal part 20 in the example is formed in a round-shaped terminal. The terminal part 20 includes a connection part 21 serving as a main part and a projecting part 22 projecting from the connection part 21 (from FIG. 1 to FIG. 5).

The terminal part 20 is fastened to a counterpart connection part 201 serving as an object to be electrically connected using a screw member (FIG. 4). Thus, a circular first through hole 21a for inserting a male screw part therethrough is formed in the connection part 21 (from FIG. 1 to FIG. 3). In this example, the connection part 21 is formed in an annular shape. However, the connection part 21 may also be formed in various shapes. In this example, as a screw member used for fastening, a bolt serving as a male screw member 210 is disposed at the terminal part 20 side, and a nut serving as a female screw member 220 is disposed at the counterpart connection part 201 side (FIG. 4). However, the female screw member 220 may be disposed at the terminal part 20 side and the male screw member 210 may be disposed at the counterpart connection part 201 side.

The projecting part 22 projects from the connection part 21 in at least one axial direction of the first through hole 21a (from FIG. 1 to FIG. 5). The projecting part 22 is provided on at least one of both ends of the connection part 21 in the axial direction of the first through hole 21a. Consequently, although the projecting part 22 is only provided at one end of the connection part 21 in this example, the projecting part 22 may also be provided at both ends of the connection part 21.

The projecting part 22 is formed in an annular shape having a circular second through hole 22a and an annular end surface 22b at the projecting direction side (from FIG. 1 to FIG. 3). The second through hole 22a is communicated to the first through hole 21a with the axial direction of the second through hole 22a identical to an axial direction of the first through hole 21a. The end surface 22b is able to come into surface contact with a contact surface 201a (FIG. 4) of the counterpart connection part 201 serving as an object to be fastened.

The projecting part 22 may also be disposed at a position where the second through hole 22a is eccentric to the first through hole 21a, or may be disposed so that the first through hole 21a and the second through hole 22a will become concentric. The connection part 21 and the projecting part 22 in the example are disposed so that the first through hole 21a and the second through hole 22a become concentric. Moreover, the first through hole 21a and the second through hole 22a in the example are formed so as to have the same inner diameter.

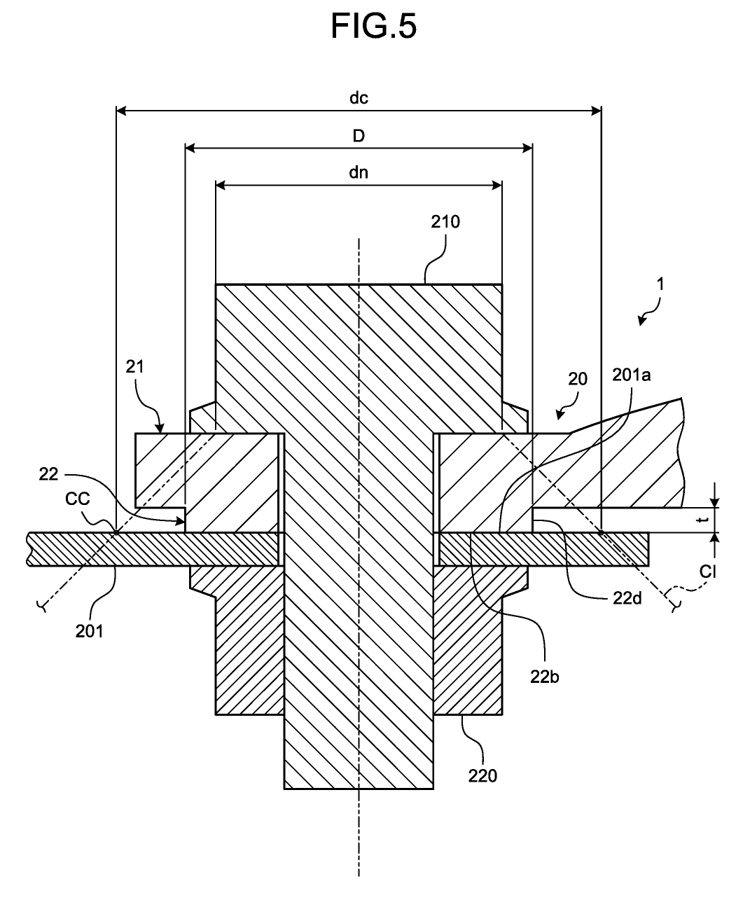

The projecting part 22 is formed in a shape so that the axial force of the screw member (axial force between the male screw member 210 and the female screw member 220) can be transmitted between the connection part 21 and the counterpart connection part 201. The shape of an inner peripheral surface 22c (FIG. 1 and FIG. 2) of the projecting part 22 is determined according to the size of the second through hole 22a through which the male screw part is inserted. On the other hand, the shape of an outer peripheral surface 22d (FIG. 1 and FIG. 2) of the projecting part 22 is determined by using a seat effective diameter dn (FIG. 5) of the screw member (in this example, the male screw member 210) that is disposed at an opposite side to the projecting part 22 in the connection part 21.

First, in this projecting part 22, an outer diameter D of the outer peripheral surface 22d (FIG. 5) is set so as to be equal to or more than the seat effective diameter dn of the screw member (in this example, the male screw member 210).

Next, the upper limit value of the outer diameter D of the outer peripheral surface 22d is set by using what is called a cone of influence CI (FIG. 5) related to the screw member (in this example, the male screw member 210). The cone of influence CI is a cone having a half apex angle of 45 degrees drawn from the position of the seat effective diameter do of the seat surface of the screw member. According to the theory of the cone of influence CI, in the projecting part 22, even though the outer diameter D of the outer peripheral surface 22d is enlarged than an outer diameter dc (FIG. 5) of a circle (hereinafter, referred to as an “intersection circle”) CC in which the curved surface of the cone of influence CI is intersected with the contact surface 201a of the counterpart connection part 201, the axial force of the screw member is hardly transmitted to the portion larger than the outer diameter dc of the intersection circle CC. Consequently, the portion larger than the outer diameter dc of the intersection circle CC is an unnecessary part, because the portion reduces the surface pressure between the end surface 22b of the projecting part 22 and the contact surface 201a of the counterpart connection part 201, and increases the contact resistance between the end surface 22b of the projecting part 22 and the contact surface 201a of the counterpart connection part 201. Moreover, the portion larger than the outer diameter dc of the intersection circle CC is a useless portion in reducing the size and weight of the physical configuration of the terminal part 20. Thus, the outer diameter D of the outer peripheral surface 22d of the projecting part 22 is set so as to be equal to or less than the outer diameter dc of the intersection circle CC between the curved surface of the cone of influence CI and the contact surface 201a of the counterpart connection part 201. Consequently, the terminal part 20 can prevent the contact resistance from increasing. Moreover, it is possible to reduce the size and weight of the terminal part 20.

In this manner, the outer diameter D of the outer peripheral surface 22d of the projecting part 22 is set so as to be equal to or more than the seat effective diameter do of the screw member (in this example, the male screw member 210), and equal to or less than the outer diameter dc of the intersection circle CC between the curved surface of the cone of influence CI and the contact surface 201a of the counterpart connection part 201. As long as it is within the range of setting condition, the outer peripheral surface 22d of the projecting part 22 may be formed so that the outer diameter D at each position in the axial direction can be uniform, or the outer diameter D at each position in the axial direction is varied. For example, the former projecting part 22 is formed in an annular cylindrical shape the outer diameter D of which has the outer peripheral surface 22d within the range of the aforementioned setting condition. Moreover, for example, the latter projecting part 22 is formed in an annular truncated conical cylindrical shape the outer diameter D of which has the outer peripheral surface 22d within the range of the aforementioned setting condition.

It is to be noted that in the projecting part 22, to form a flat or curved chamfered part on the corner of the end surface 22b at the outer peripheral surface 22d side, the outer diameter D of the end surface 22b is set so as to be equal to or more than the seat effective diameter dn of the screw member (in this example, the male screw member 210), and equal to or less than the outer diameter dc of the intersection circle CC between the curved surface of the cone of influence CI and the contact surface 201a of the counterpart connection part 201.

As described above, the terminal part 20 of the terminalized electric wire 1 of the present embodiment is provided with the projecting part 22 having the outer peripheral surface 22d the outer diameter D of which is equal to or more than the seat effective diameter dn of the screw member (in this example, the male screw member 210), and equal to or less than the outer diameter do of the intersection circle CC between the curved surface of the cone of influence CI and the contact surface 201a of the counterpart connection part 201. Consequently, even when the connection part 21 is formed in any desired shape, by providing the projecting part 22 as described above, the terminal part 20 can prevent the change in the contact resistance between the end surface 22b of the projecting part 22 and the contact surface 201a of the counterpart connection part 201. Thus, the terminalized electric wire 1 of the present embodiment is capable of increasing the flexibility of setting the shape of the terminal part 20, while ensuring a good conduction state between the terminal part 20 and the counterpart connection part 201.

For example, the terminalized electric wire 1 allows, even when the electric wire 10A having a different wire diameter is to be transformed into a terminal, the connection part 21 to be formed into any desired shape while maintaining the conduction performance between the terminal part 20 and the counterpart connection part 201, as long as the projecting part 22 with the aforementioned setting condition is provided. Moreover, the terminalized electric wire 1 allows, even when a gap between the terminal part 20 and the other peripheral component is about to fall below the design reference value, the connection part 21 to have a concave, a notch, or the like so as to fill the gap between the terminal part 20 and the other component, while keeping the conductive performance between the terminal part 20 and the counterpart connection part 201, as long as the projecting part 22 with the aforementioned setting is provided.

In the projecting part 22, it is preferable to set a thickness t (FIG. 5) in the axial direction so that the terminal part 20 will not come into contact with the counterpart connection part 201 with the deformation of the terminal part 20, for example. That is, in the projecting part 22, it is preferable to set the thickness t (FIG. 5) in the axial direction so that the contact area between the end surface 22b and the contact surface 201a of the counterpart connection part 201 will not be changed with the deformation of the terminal part 20, for example. Consequently, even when deformation occurs in the terminal part 20, it is possible to prevent the change in the contact resistance between the end surface 22b of the projecting part 22 and the contact surface 201a of the counterpart connection part 201.

It is to be noted that the shape of the terminal part 20 may be applied to a terminal fitting (a member connected to the terminal of the electric wire by compression and the like), as long as the terminal fitting includes the projecting part 22 with the aforementioned setting condition.

The terminal part is provided with a projecting part having the outer peripheral surface the outer diameter of which is equal to or more than the seat effective diameter of the screw member for fastening, and equal to or less than the outer diameter of the intersection circle between the curved surface of the cone of influence and the contact surface of the counterpart connection part. Consequently, even though the connection part is formed in any desired shape, by providing the projecting part as described above, the terminal part can prevent the change in the contact resistance between the end surface of the projecting part and the contact surface of the counterpart connection part. Thus, the terminalized electric wire according to the present embodiment is capable of increasing the flexibility of setting the shape of the terminal part, while ensuring a good conduction state between the terminal part and the counterpart connection part.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminalized electric wire, comprising:
an electric wire part including a conductive core wire; and
a terminal part in which an object to be terminalized of the core wire is solidified into a terminal shape after being melted, wherein
the terminal part includes a connection part having a first through hole for inserting a male screw part therethrough, and a projecting part projecting from the connection part in one of axial directions of the first through hole,
the projecting part is formed in an annular shape including a second through hole communicated to the first through hole with an axial direction identical to an axial direction of the first through hole, and an end surface at a projecting direction side of the annular shape that is able to come into surface contact with a contact surface of a counterpart connection part serving as an object to be fastened, and
an outer diameter of an outer peripheral surface of the projecting part is set so as to be equal to or more than a seat effective diameter of a screw member for fastening that is disposed at an opposite side to the projecting part in the connection part, and equal to or less than an outer diameter of an intersection circle between a curved surface of a cone of influence relating to the screw member and the contact surface of the counterpart connection part.

2. The terminalized electric wire according to claim 1, wherein
the projecting part is formed in an annular cylindrical shape or an annular truncated conical cylindrical shape having the outer peripheral surface.

3. The terminalized electric wire according to claim 1, wherein
the projecting part is provided on at least one of both ends of the connection part in the axial direction of the first through hole.

4. The terminalized electric wire according to claim 2, wherein
the projecting part is provided on at least one of both ends of the connection part in the axial direction of the first through hole.

5. The terminalized electric wire according to claim 1, wherein
the connection part and the projecting part are disposed so that the first through hole and the second through hole become concentric.

6. The terminalized electric wire according to claim 2, wherein
the connection part and the projecting part are disposed so that the first through hole and the second through hole become concentric.

7. The terminalized electric wire according to claim 3, wherein
the connection part and the projecting part are disposed so that the first through hole and the second through hole become concentric.
